(19) United States
(12) Patent Application Publication
(10) Pub. No.: US 2005/0036177 A1
(43) Pub. Date: Feb. 17, 2005

(54) Optical image scanner with reduced optical head profile

(76) Inventors: Rodney Carl Harris, Fort Collins, CO (US); Kurt Eugene Spears, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/638,788

(22) Filed: Aug. 11, 2003

(51) Int. Cl. H04N 1/04; H04N 1/10; H04N 1/19

(52) U.S. Cl. 358/474; 358/494; 358/484; 358/497

(57) ABSTRACT

Optical image scanners with a reduced optical head profile are provided. One embodiment is an optical image scanner having a reduced optical head profile. Briefly described, one such optical image scanner comprises an optical head assembly having a scanline axis and a translation system for translating the optical head assembly. The translation system is positioned within a cross-sectional width of the optical head assembly along the scanline axis of the optical head assembly.

### BACKGROUND

Optical image scanners, also known as document scanners, convert a visible image (e.g., on a document or photograph, an image in a transparent medium, etc.) into an electronic form suitable for copying, storing, or processing by a computer. An optical image scanner may be a separate device, or an image scanner may be a part of a copier, part of a facsimile machine, or part of a multipurpose device. Reflective image scanners typically have a controlled source of light that is reflected off the surface of a document, through an optics system, and onto an array of photosensitive devices (e.g., a charge-coupled device, complimentary metal-oxide semiconductor (CMOS), etc.). Transparency image scanners pass light through a transparent image (e.g., a photographic positive slide), through optics, and then onto an array of photosensitive devices. The optics focus at least one line, called a scanline, of the image being scanned, onto the array of photosensitive devices. The photosensitive devices convert received light intensity into an electronic signal. An analog-to-digital converter converts the electronic signal into computer-readable binary numbers, with each binary number representing an intensity value.

There are two common types of optical image scanners. In a first type, a single reduction lens system is commonly used to focus the scanline onto the photosensor array, and the length of the photosensor array is much less than the length of the scanline. In a second type, an array of many lenses is used to focus the scanline onto the photosensor array, and the length of the photosensor array is the same length as the scanline. For the second type, it is common to use Selfoc® lens arrays (SLA) (available from Nippon Sheet Glass Co.), in which an array of rod-shaped lenses is used, typically with multiple photosensors receiving light through each individual lens.

### SUMMARY

Embodiments of the present invention provide a reduced optical head profile in an optical image scanner.

One embodiment is an optical image scanner having a reduced optical head profile. Briefly described, one such optical image scanner comprises an optical head assembly having a scanline axis and a translation system for translating the optical head assembly. The translation system is positioned within a cross-sectional width of the optical head assembly along the scanline axis of the optical head assembly.

Another embodiment is a method for reducing the optical head profile of an optical image scanner. Briefly described, one such method comprises providing an optical head having a scanline axis and positioning a translation system within a cross-sectional width of the optical head along the scanline axis of the optical head.

A further embodiment is a method of translating an optical head assembly in an optical image scanner. Briefly described, one such method comprises engaging a portion of an optical head assembly within a cross-sectional width of the optical head assembly along the scanline axis of the optical head assembly.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cross-sectional view of an embodiment of an optical image scanner having a reduced optical head profile in both vertical and horizontal dimensions.

FIG. 2 is a side view of the drive belt in the optical image scanner of FIG. 1.

FIG. 3 is a side cross-sectional view of the optical image scanner of FIG. 1, illustrating the components of the optical head assembly.

FIG. 4 is an overhead view of the optical image scanner of FIGS. 1 & 3.

FIG. 5 is a side view of the drive belt of FIG. 2 integrated with the optical head holder in the optical image scanner of FIG. 1

### DETAILED DESCRIPTION

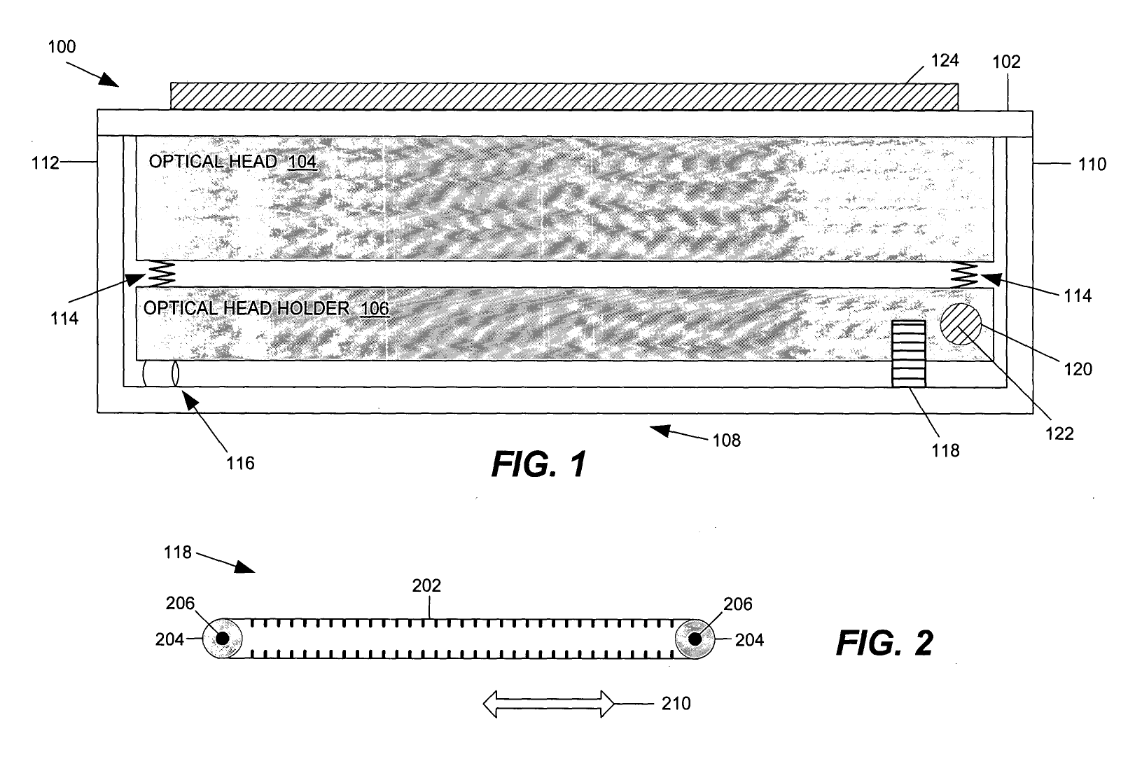

This disclosure relates to various embodiments of optical image scanners having a reduced optical head profile. Various embodiments will be described below with reference to FIGS. 1-5. As an introductory matter, however, various types of optical image scanners include an optical head assembly comprising the optical and/or electrical components for generating an image of an object being scanned. Generally, the optical components in the optical head assembly focus at least one line (i.e., a scanline). In this regard, the optical head assembly includes a scanline axis. As known in the art, the optical image scanner scans an entire image by translating the optical head assembly relative to the object being scanned. A translation system (e.g., a drive belt, cable, wire, etc.) moves the optical head assembly along a translation axis, thereby “sweeping” the focused scanline along the translation axis. Various embodiments of the present invention are intended to be utilized with various types of scanners.

Image scanners may be manufactured to be small in size and/or user-friendly. Various embodiments of optical image scanners of the present invention are provided in which the optical head profile is reduced. The optical head profile refers to the cross-sectional height and/or width of the optical image scanner along the scanline axis.

FIG. 1 illustrates the optical head profile of an embodiment of an optical image scanner 100. As illustrated in FIG. 1, optical image scanner 100 comprises an optical head 104 (also known as a carriage) positioned relative to a transparent platen 102 within a housing 108 between sides 112 and 110. An object, such as a document 124, may be placed on the top surface of the platen 102 for scanning. Optical image scanner 100 may be included within an optical image scanner (e.g., a low profile flatbed scanner), a facsimile machine, copier, multipurpose printer, or other electronic device.

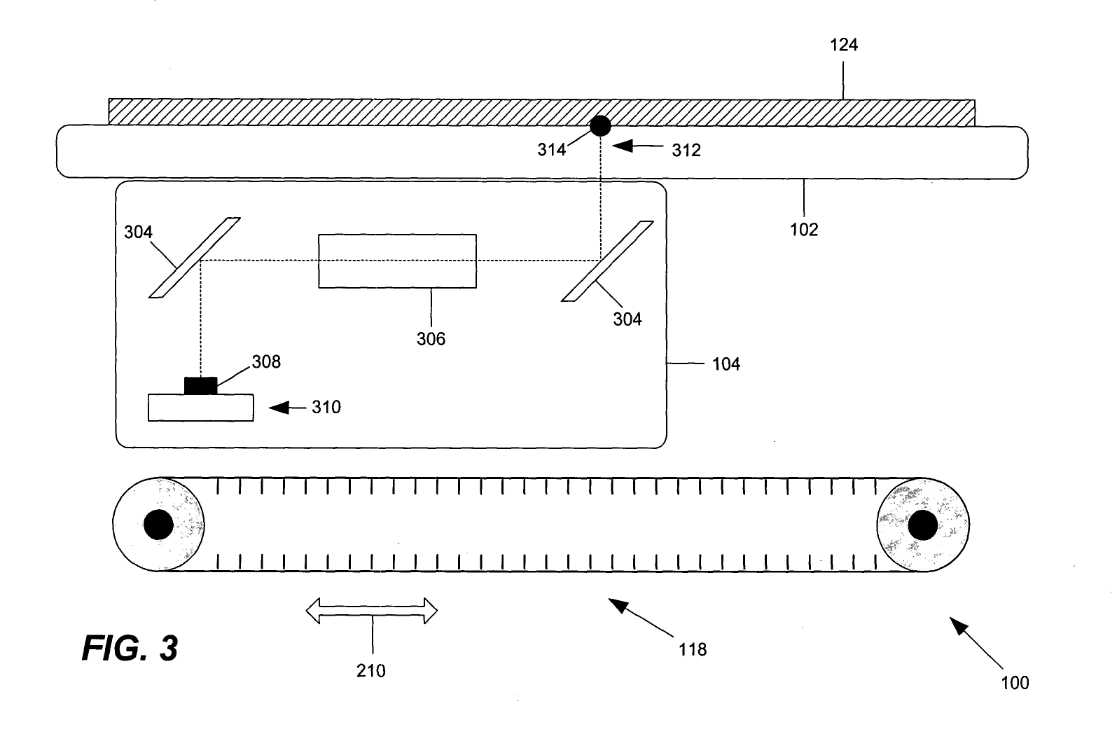

Referring to FIG. 3, various components of an embodiment of optical head 104 will be described. As illustrated in FIG. 3, optical head 104 comprises a first reflective surface 304 (e.g., mirror, etc.), a lens array 306, a second reflective surface 304, and an image sensor module 310. Image sensor module 310 may comprise, for example, a printed circuit assembly or any other semiconductor device. Image sensor module 310 also includes a photosensor array 308, which may be any type of device configured to receive optical signals and convert the light intensity into an electronic signal. For example, as known in the art, photosensor array 308 may comprise a charge-coupled device (CCD), complimentary metal-oxide semiconductor (CMOS), or other device.

Lens array 306 may comprise an array of rod-shaped lenses that have a relatively short depth of focus. For example, lens array 306 may comprise a Selfoc® lens array (SLA), which is manufactured and sold by Nippon Sheet Glass Co. of Somerset, N.J. A rod-lens array may comprise at least one row of graded-index micro lenses, which may be equal in dimensions and optical properties. The lenses may be aligned between two fiberglass-reinforced plastic (FRP) plates. Because FRP has a coefficient of thermal expansion equal to glass, thermal distortion and stress effects are minimal. The FRP also increases mechanical strength of the SLA. The interstices may be filled with black silicone to prevent flare (crosstalk) between the lenses and protect each individual lens.

As a document 124 is being scanned by optical head 104, an optical signal 312 is reflected off the document 124 and towards the first reflective surface 304 to an object plane 314. The first reflective surface 304 directs the optical signal 312 through the lens array 306 to be focused. The optical signal 312 may also be reflected toward image sensor module 310 by an optional second reflective surface 304. The optical signal 312 is received by photosensor array 308 and converted into an electronic signal, which may be processed by an analog-to-digital converter, digital signal processor, etc. In this manner, the optics within optical head 104 focus a portion of an image of document 124 onto photosensor array 308.

The optical and/or electrical components employed within optical head 104 and the arrangement of these components may be provided in a number of alternative ways. For instance, in order to alter the cross-sectional profile of optical head 104, second reflective surface 304 may be removed and the image sensor module 310 may be perpendicularly oriented to the optical axis of lens array 306 to receive optical signal 312. Alternatively, the optical axis of lens array 306 may be perpendicularly oriented to platen 102 to direct light through lens array 306 and onto photosensor array 308.

Referring again to FIGS. 1 and 2, optical image scanner 100 includes a translation system for translating optical head 104 in a direction perpendicular to the scanline axis of optical head 104 along a translation axis as indicated by reference number 210 (FIG. 2). In this regard, the embodiment of optical image scanner 100 illustrated in FIGS. 1 and 2 also includes an optical head holder 106, a drive belt 118, and a guide rod 122.

As illustrated in FIG. 1, optical head holder 106 provides a base for optical head 104. Optical head holder 106 mechanically references optical head 104 relative to the lower surface of platen 102. For example, one or more biasing or resilient members, such as spring assemblies 114, may be disposed between optical head 104 and optical head holder 106 for pressing optical head 104 against platen 102.

Optical head holder 106 also provides a mechanism by which the translation system may engage optical head 104. As illustrated in FIG. 1, optical image scanner 100 includes idler(s) 116, a guide rod 122, and a drive belt 118, each of these components being positioned within the cross-sectional width of the optical head profile. In other words, idler(s) 116, guide rod 122, and drive belt 118 are not positioned outside the width of optical head 104. In this manner, sides 110 and 112 of housing 108 may be located nearer to the respective sides of optical head 104 and thus reduce the optical head profile and provide a narrower product footprint.

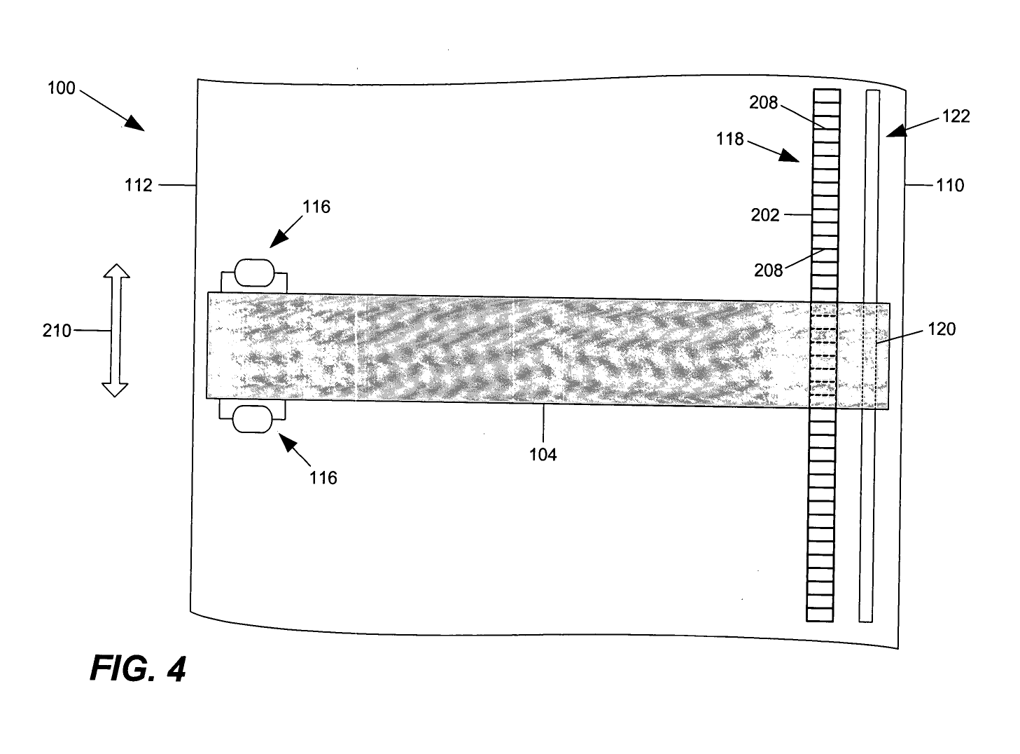

As best illustrated in FIGS. 1 and 4, guide rod 120 extends in a parallel relationship relative to side 110 of housing 108 within an aperture 120 formed in optical head holder 106. This arrangement provides mechanical support and a motion reference as drive belt 118 engages optical head holder 106 to translate optical head 104.

Idler(s) 116 provide additional mechanical reference during translation of optical head 104. Idler(s) 116 are attached to optical head holder 106 and extend toward the base of housing 108. As best illustrated in FIG. 4, idler(s) 116 slidably engage the upper surface of the base as optical head 104 is translated along translation axis 210. In one of a number of embodiments, idler(s) 116 comprise a bushing, wheel, or other similar device.

Referring to FIG. 2, drive belt 118 includes a belt 202 wrapped around two pulleys 204. During operation, drive belt 118 rotates around axes 206. Drive belt 118 is positioned in such a manner that rotational axes 206 are horizontally arranged relative to the scanline axis of optical head 104. As drive belt 118 engages optical head holder 106, optical head 104 is moved along translation axis 210. In this regard, one or both pulley(s) 204 are operationally connected to a drive motor (not shown) that provides the rotational force.

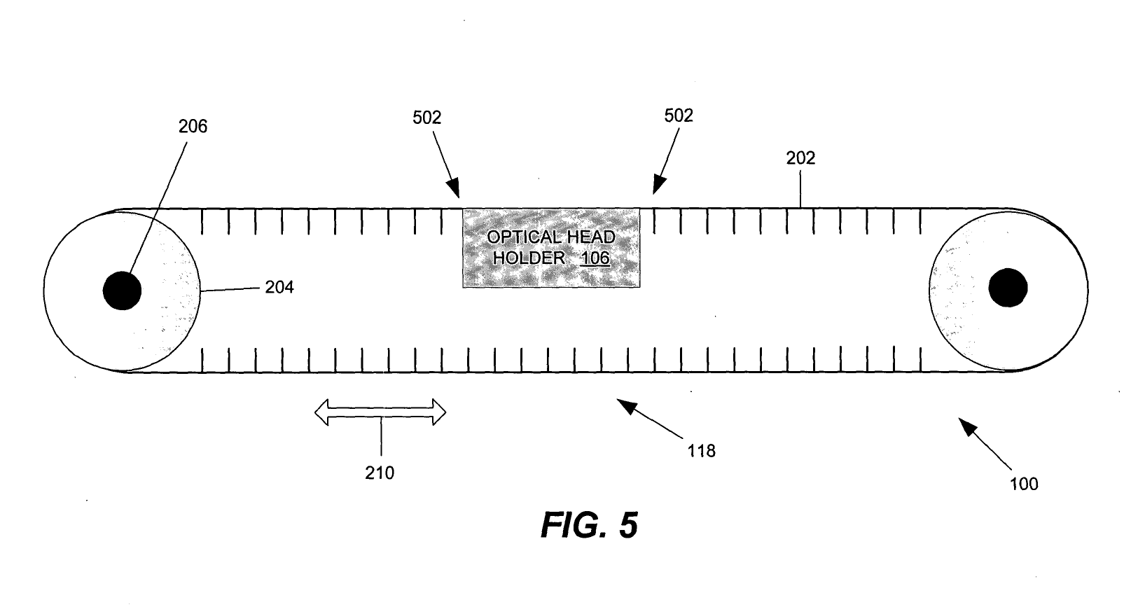

Referring to FIG. 5, the horizontal arrangement of axes 206 enables optical head holder 106 to share vertical space with belt 202. In this regard, in alternative embodiments, belt 202 is discontinuous. As illustrated in FIG. 5, belt 202 may include two ends 502 that are attached to opposite sides of optical head holder 106. As further illustrated in FIG. 5, the vertical height of optical image scanner 100 may be reduced because drive belt 118 and optical head holder 106 share vertical space within housing 108. This vertical space saving arrangement may be combined with the horizontal space saving arrangement provided by locating idler(s) 116, guide rod 122, and/or drive belt 118 within the cross-sectional width of the optical head profile (as described above) to achieve a product footprint of reduced vertical and horizontal dimensions.

The translation system may comprise a number of alternative mechanisms for providing the force for translating optical head 104. For example, drive belt 118 may be replaced by a drive cable, wire, or other mechanical means.

1. An optical image scanner having a reduced optical head profile, comprising:
an optical head assembly having a scanline axis; and
a translation system for translating the optical head assembly, the translation system positioned within a cross-sectional width of the optical head assembly along the scanline axis of the optical head assembly.

2. The optical image scanner of claim 1, wherein the translation system comprises a drive belt positioned within the cross-sectional width of the optical head assembly along the scanline axis.

3. The optical image scanner of claim 2, wherein the drive belt is positioned below the optical head assembly.

4. The optical image scanner of claim 2, wherein the drive belt comprises first and second ends connected to opposite sides of the optical head assembly

5. The optical image scanner of claim 2, wherein a rotational axis of the drive belt is horizontally arranged relative to the scanline axis of the optical head assembly.

6. The optical image scanner of claim 2, wherein the optical head assembly comprises an optical head and an optical head holder engaged by the translation system.

7. The optical image scanner of claim 6, wherein the translation system comprises a guide rod positioned through an aperture in the optical head holder.

8. The optical image scanner of claim 6, wherein the optical head holder and the optical head are mechanically referenced by a biasing assembly that positions the optical head below the lower surface of a transparent platen.

9. The optical image scanner of claim 1, wherein the translation system comprises a drive cable.

10. The optical image scanner of claim 1, wherein the translation system comprises an idler positioned within the cross-sectional width of the optical head assembly along the scanline axis.

11. The optical image scanner of claim 10, wherein the idler comprises a bushing that engages a base of the optical image scanner.

12. The optical image scanner of claim 1, wherein the translation system comprises an idler and a drive belt positioned within the cross-sectional width of the optical head assembly along the scanline axis.

13. A method for reducing the optical head profile of an optical image scanner, the method comprising:
providing an optical head having a scanline axis; and
positioning a translation system within a cross-sectional width of the optical head along the scanline axis of the optical head.

14. The method of claim 13, wherein the positioning the translation system within the cross-sectional width of the optical head along the scanline axis of the optical head comprises locating an idler within the cross-sectional width of the optical head along the scanline axis of the optical head.

15. The method of claim 13, wherein the positioning the translation system within the cross-sectional width of the optical head along the scanline axis of the optical head comprises locating a drive belt within the cross-sectional width of the optical head along the scanline axis of the optical head.

16. The method of claim 15, wherein the locating a drive belt within the cross-sectional width of the optical head along the scanline axis of the optical head further comprises positioning a rotational axis of the drive belt in a horizontal relationship with the scanline axis of the optical head.

17. The method of claim 15, wherein the locating a drive belt within the cross-sectional width of the optical head along the scanline axis of the optical head further comprises attaching first and second ends of the drive belt to opposite sides of the optical head assembly.

18. A method of translating an optical head assembly in an optical image scanner, the method comprising engaging a portion of an optical head assembly within a cross-sectional width of the optical head assembly along a scanline axis of the optical head assembly.

19. The method of claim 18, wherein the engaging a portion of the optical head assembly comprises attaching first and second ends of a drive belt to opposite sides of the optical head assembly.
